(19) United States
(12) Patent Application Publication
(10) Pub. No.: US 2004/0188130 A1
(43) Pub. Date: Sep. 30, 2004

(54) Method and apparatus for dressing substantially parallel cables

(76) Inventor: Humberto Herrera, Pomona, CA (US)

Correspondence Address: Jack I. J'maev, SUITE 110, 11800 CENTRAL AVE., CHINO, CA, 91710, US

(21) Appl. No.: 10/403,813

(22) Filed: Mar. 28, 2003

(51) Int. Cl. H01B 7/08

(52) U.S. Cl. 174/117 F

(57) ABSTRACT

Linear ribbon cables having data or communication cables are used to interconnect data or telephony subsystems. Alternatively, the decorative shroud is disposed about a collection of cables to contain them in an aesthetically pleasing manner.

### FIELD OF THE INVENTION

This invention relates generally to interconnect wiring of communication subsystems; and specifically to wiring telecommunications and network subsystems using linearly joined network cabling.

### BACKGROUND OF THE INVENTION

Much of today's modern world as we know it today has been brought about through advances in communications technology. First, telephony allowed people to communicate over short distances. As technology evolved, it was not long before global telecommunications became commonplace. The Internet has done for computers what the global telephone infrastructure had done for people. Namely, computers can now communicate with each other irrespective of where they might be located.

Many of the advances in telephone and data communications technology have been brought about through the continued evolution of integrated circuit technology. The integrated circuit has enabled communications system designers to develop sophisticated telecommunications equipment that require less space and provide a rich complement of features that could not even have been imagined two to three decades ago.

Although it has been the integrated circuit that has enabled much of the technology that we take for granted today, there are still some basic technologies that support the continually expanding communications infrastructure. For example, the vast majority of the communications infrastructure deployed throughout the world still relies on a physical cable to carry telephony and data from one point to another. At just about every level, a cable is used to connect one communications subsystem to another. What has changed is the type of cabling that is used today; category five (CAT-5) cables for local network data and fiber optic cables for long-haul applications are just two examples of the type of cables that are used today. Even still, cable is and continues to remain a critical component and the communications infrastructure we use on a daily basis would fail for lack of these simple cables.

In order to continue growing and the communications infrastructure, various subsystems need to be installed at diverse locations. In many cases, subsystems within a particular location need to be interconnected in order to enable their functions. Because of its popularity, network data cables (e.g. CAT-5 cable) are often used to connect to communications subsystems to other subsystems or to telephone and data access ports. The amount of effort expended in the installation of communications subsystems and the wiring of “drop” ports is a significant cost factor in any new communications system deployment.

One of the most time-consuming aspects of installing a communications system is that of “pulling” cable in between subsystems or between a subsystem and an access port. This process is typically accomplished in a random manner and results in a veritable rats-nest of cabling. In order to complete the installation, additional labor is required to straighten the cabling. For the most part, this additional step is not really necessary, but it results in a much more aesthetically pleasing installation. Instead of the rats-nest, the cable installation appears to comprise the plurality of neatly placed linearly adjacent cables.

### SUMMARY OF THE INVENTION

What is necessary, then, is a means for dressing cables that are substantially parallel, but are not necessarily linearly adjacent. Such a method must not require the labor typically associated with straightening and dressing these cables in order to achieve aesthetically pleasing appearance. The present invention comprises a method for interconnecting communication or network subsystems that results in an aesthetically pleasing installation.

One variation of the present method provides for determining the distance between two subsystems and then determining the number of ports required for interconnection. Based upon this information, a length of ribbon cable is selected. The ribbon cable itself, which further constitutes the present invention, comprises a plurality of linearly adjacent communications or network cables. The length of individual cables constituting the ribbon cable may be adjusted on one end of the ribbon cable to account for varying positions in connectors in a subsystem to which that particular end of the ribbon cable will be mated with. Once this is accomplished, the individual cables constituting the ribbon cable may be terminated with connectors that can be mated to receptacles constituting a first network subsystem. Once the ribbon cable is mated to the first subsystem, it may be disposed in a cable-way. A cable may then be fanned away from the ribbon cable. This cable may then be directed to an access port. Some cases, the method of the present invention may provide for adjusting the number of individual cables constituting the ribbon cable in accordance with the number of ports that must be interconnected between a first subsystem and a second subsystem. The ribbon cable may be optionally formed into a bundle by rolling it in a spiral manner.

According to one alternative method of the present invention, communications or network cables that are substantially parallel to each other may be contained in a bundle. The bundle may then be encased in a decorative shroud. According to one variation of the present method, a decorative shroud may comprise a linear casing comprising a ribbon cable facade. In yet another variation of the present method, the bundle of cables may be encased in a linear ribbon cable that is formed about the bundle and restrained in place. Containing the bundle prior to encasement in the decorative shroud may be accomplished by wrapping the plurality of cables with a restraint at intervals.

The present invention further comprises a ribbon cable itself comprises a plurality of cables that are fixed in a side-by-side arrangement. These cables are typically selected from a group consisting communications cable and network cable. The cables may be held in the side-by-side arrangement by a common insulator that encapsulated the plurality of cables. Likewise, an alternative embodiment of the invention fixes the cables in place relative to each other through the use of an adhesive that is minimally deposited between the cables. In yet another alternative embodiment of the invention, the ribbon cable is constructed by attaching the plurality of cables to inflexible planar that is attached to the perimeter of each cable. The present invention further comprises a linear cable casing comprising a linear strip having an internal and an external surface. The external surface comprises a ribbon cable facade.

### BRIEF DESCRIPTION OF THE DRAWINGS

The foregoing aspects are better understood from the following detailed description of one embodiment of the invention with reference to the drawings, in which:

FIG. 1A is a flow diagram that depicts one example method for dressing linearly adjacent cables according to the present invention;

FIG. 1B is a continuation of the flow diagram presented in FIG. 1 for dressing linearly adjacent cables according to the present invention;

FIGS. 2A, 2B and 2C constitute a flow diagram that depicts one alternative method for dressing linearly adjacent cables according to the present invention;

FIG. 3 is a pictorial diagram that depicts one embodiment of a ribbon cable according to the present invention for interconnecting one subsystem to another;

FIG. 4 is a pictorial diagram that depicts the use of a ribbon cable to connect a subsystem to an access port according to the present invention;

FIG. 5 is a pictorial that depicts the structure of a ribbon cable after it has been bundled according to method of the present invention;

FIG. 6A is a pictorial diagram depicting one example structure for a ribbon cable comprising a plurality of communications and/or network cables according to the present invention;

FIG. 6B is a pictorial diagram that depicts one alternative embodiment of the ribbon cable comprising a plurality of network and/or telecommunications cables according to the present invention;

FIG. 7 is a pictorial diagram of one example embodiment of a decorative shroud according to the present invention;

FIG. 8 is a pictorial diagram that depicts one alternative embodiment of a decorative shroud according to the present invention; and

FIG. 9 is a pictorial diagram that depicts the usage of the decorative shroud to encase a bundle of network or communications cables according to the teachings of the present invention.

### DETAILED DESCRIPTION OF THE INVENTION

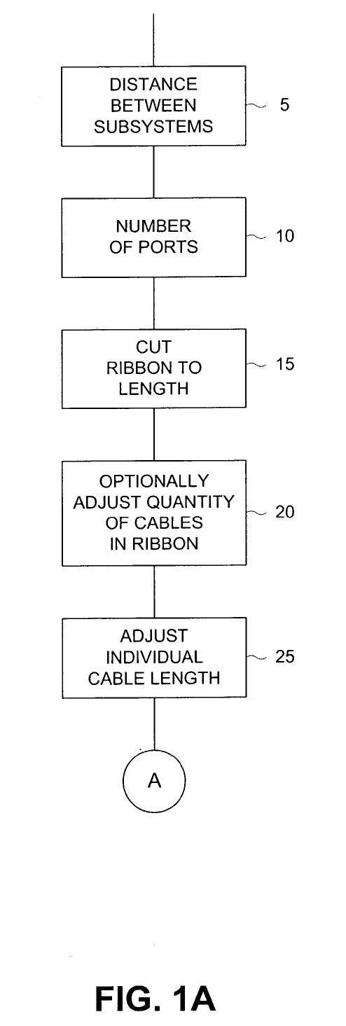

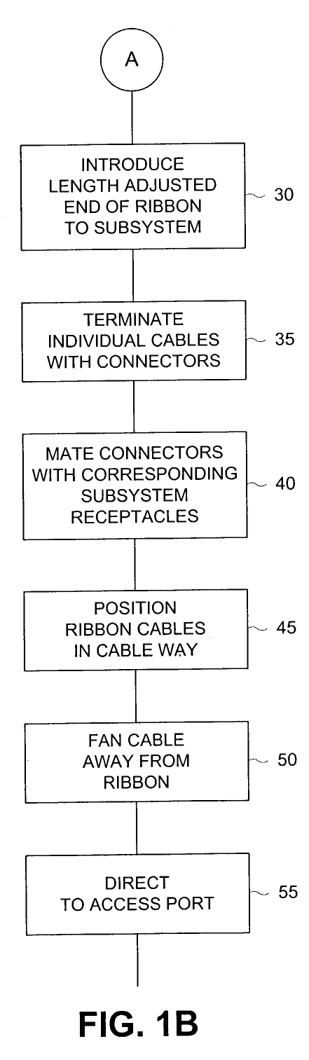

FIG. 1A is a flow diagram that depicts one example method for dressing linearly adjacent cables according to the present invention. First, the distance between two subsystems that must be wired together must be determined (step 5). Also, the number of ports that must be connected from one subsystem to the next must also be determined (step 10). An amount of ribbon cable is cut the length (step 15) in order to accommodate the distance between the two subsystems. This ribbon cable typically comprises a plurality of network or communications cable, for example CAT-5 cable. It should be noted that any type of network or commutations cable may be utilized in the ribbon. Also, it may be necessary to adjust the number of cables that constitute the ribbon cable according to the number of ports that must be connected from one system to the next (step 20). Then, the length of individual cables in the ribbon cable must be adjusted (step 25) in order to accommodate the location of connections made from the ribbon cable to a subsystem.

FIG. 1B is a continuation of the flow diagram presented in FIG. 1 for dressing linearly adjacent cables according to the present invention. Accordingly, once the individual cables in the ribbon cable are adjusted to length, this length adjusted end may then be introduced to a subsystem (step 30). The individual cables to the ribbon cable may then be terminated with connectors (step 35). Typically, the connectors are mated (step 40) with corresponding connectors comprising the subsystem (e.g. receptacles). The ribbon cable may then be positioned in a cable way (step 45). A cable may then be fanned away from the ribbon (step 50) and directed to an access port (step 55).

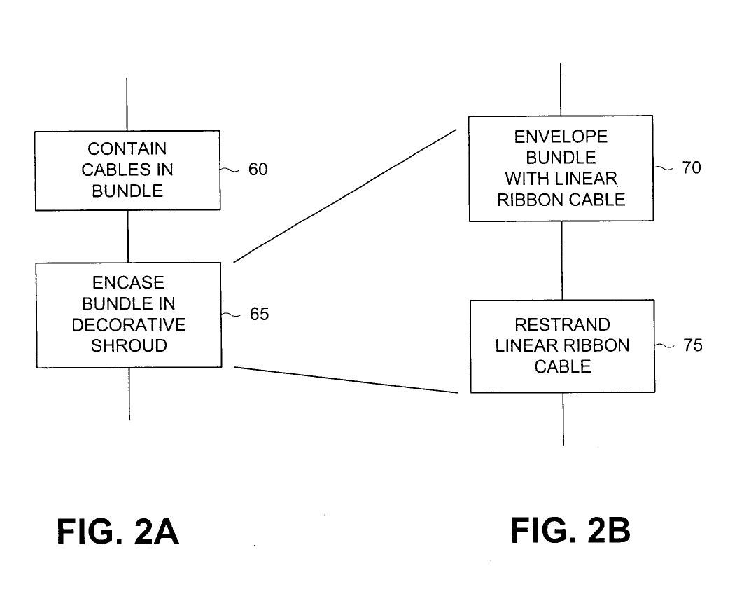

FIGS. 2A, 2B and 2C constitute a flow diagram that depicts one alternative method for dressing linearly adjacent cables according to the present invention. According to this alternative method, cables may be contained in a bundle (step 60) and then encased in a decorative shroud (step 65). Encasing the cable bundle in a decorative shroud may be accomplished by enveloping the bundle with linear ribbon cable (step 70) and then restraining the linear ribbon cable about the bundle (step 75). According to one alternative variation of this method, the cable bundle is enveloped with a ribbon cable facade casing (step 80). This casing may then be restrained about the bundle (step 85).

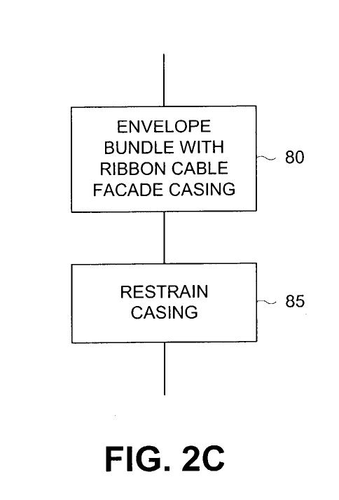

FIG. 3 is a pictorial diagram that depicts one embodiment of a ribbon cable according to the present invention for interconnecting one subsystem to another. According to this illustrative embodiment, a plurality of communication or network cables 91 are held together linearly to form a ribbon cable 100. At one end of the ribbon cable 100, the length of individual cables is adjusted corresponding to the placement of connectors 105 (e.g. receptacles) constituting a communications or networking subsystem 90. Individual cables 91 are also fanned away from the ribbon cable in a like manner (i.e. corresponding to the placement of connectors 105 constituting a subsystem 90).

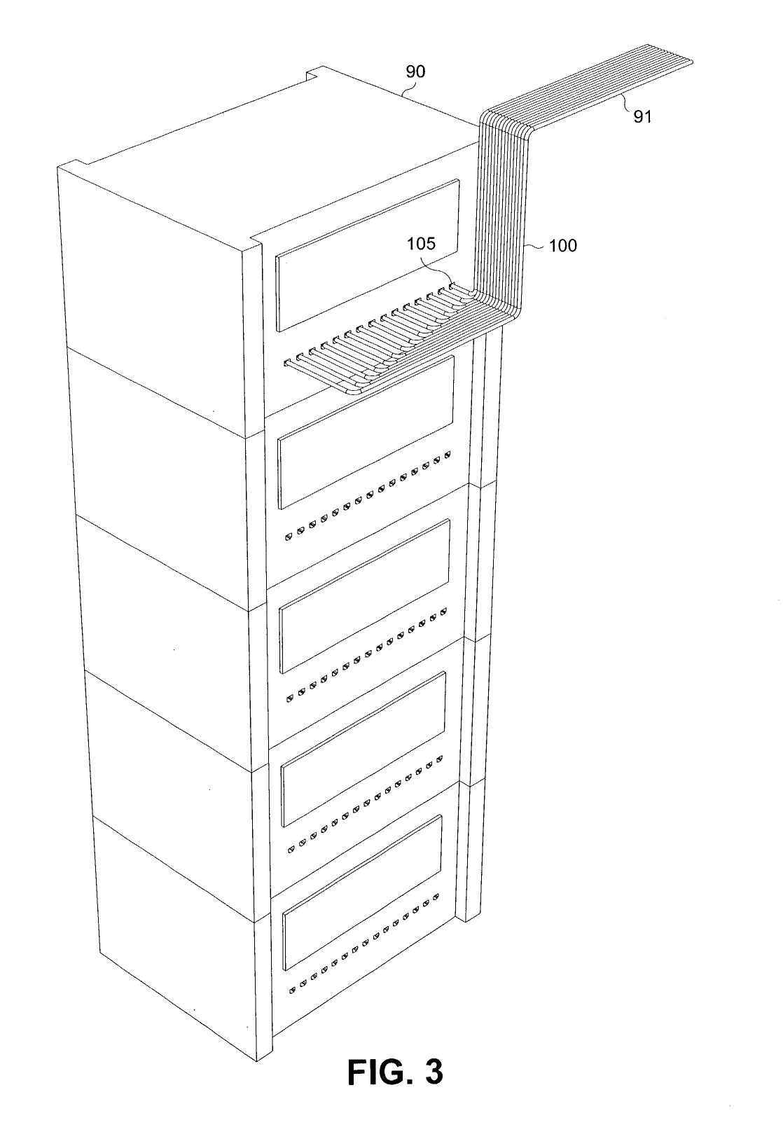

FIG. 4 is a pictorial diagram that depicts the use of a ribbon cable to connect a subsystem to an access port according to the present invention. Once individual ribbons and the ribbon cable are connected to a subsystem in a subsystem rack 115, the ribbon cable may be disposed in a cable way 125. As the ribbon cable 120 proceeds through an installation, an individual ribbon 117 may be fanned away from the ribbon cable 120 and directed to an access port 130.

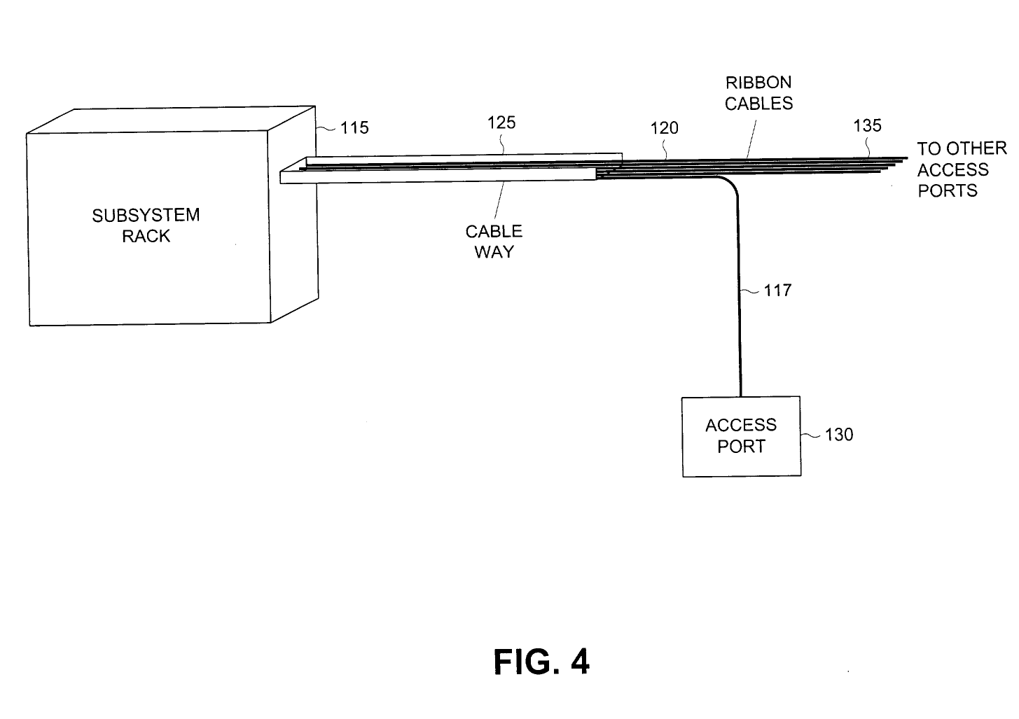

FIG. 5 is a pictorial that depicts the structure of a ribbon cable after it has been bundled according to method of the present invention. According to one alternative method of the present invention, a ribbon cable 120 emanating from a system subrack 115 may be rolled into a spiral bundle 140. Individual cables 91 in the ribbon cable 120 typically progressed from one side of the ribbon cable which is positioned substantially at the center of the spiral 145. The outermost end of the spiral 145 is generally associated with the other side of the ribbon cable.

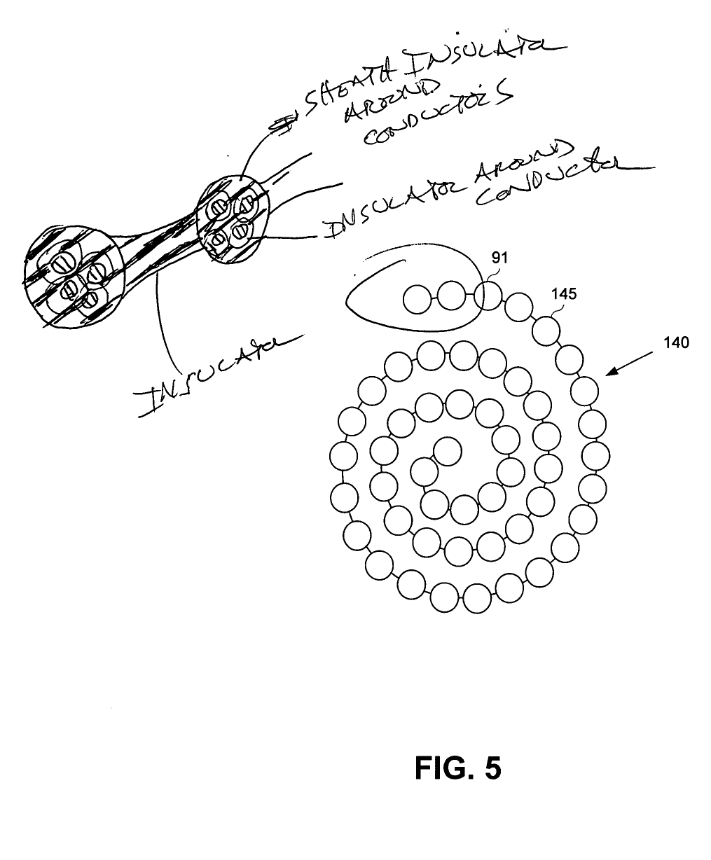

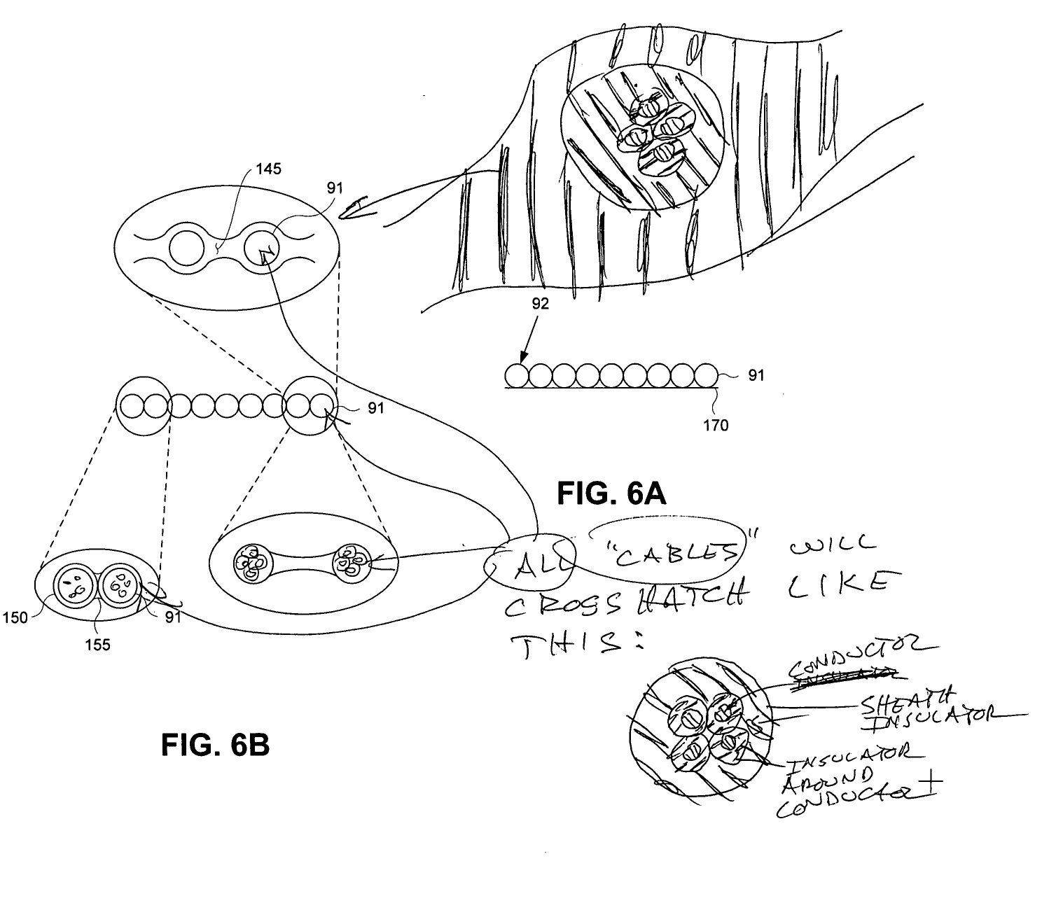

FIG. 6A is a pictorial diagram depicting one example structure for a ribbon cable comprising a plurality of communications and/or network cables according to the present invention. According to this example of embodiment, a plurality of individual cables 91 are attached to a flexible planner component 170. The individual cables 91 are typically attached tangent to their outermost perimeter and are spaced substantially at the distance equal to the diameter of an individual cable 92. However, the spacing between individual cables may be varied according to various applications. For example, the individual cables 91 are may be spaced greater then the distance equal to their diameter ribbon cable that is intended to interface directly with a plurality of connectors, e.g. in a subsystem. The flexible planner component 170 may be any type of a flexible material. For example, a pliable form of polyvinyl chloride or poly-tetra-fluoro-ethylene (PTFE) may be used. These, however, are only examples of the type of material that may be used and are not intended to limit the scope of the present invention. Attachment may be accomplished by any suitable adhesive that is disposed onto the planner component 170. According to one alternative embodiment of the invention, the planner surface 170 may be thermally fused to an insulative jacket constituting an individual cable 91.

FIG. 6B is a pictorial diagram that depicts one alternative embodiment of the ribbon cable comprising a plurality of network and/or telecommunications cables according to the present invention. According to this alternative embodiment of the invention, a ribbon cable may be constructed by adhering the insulative jacket 150 of one cable 91 to another. Typically, this is accomplished linearly along each of the two cables. One cable may be adhered to another using any suitable adhesive, which may, for example, be deposited at the junction 155 of the two insulative jackets as the two cables are positioned in a linearly adjacent manner. According to yet another alternative embodiment of the present invention, a plurality of cables may be drawn into a single insulative jacket 145. These alternative embodiments are intended to depict the variety of means for fabricating a ribbon cable comprising network or telehphonic cables and these examples are not intended to limit the scope of the present invention.

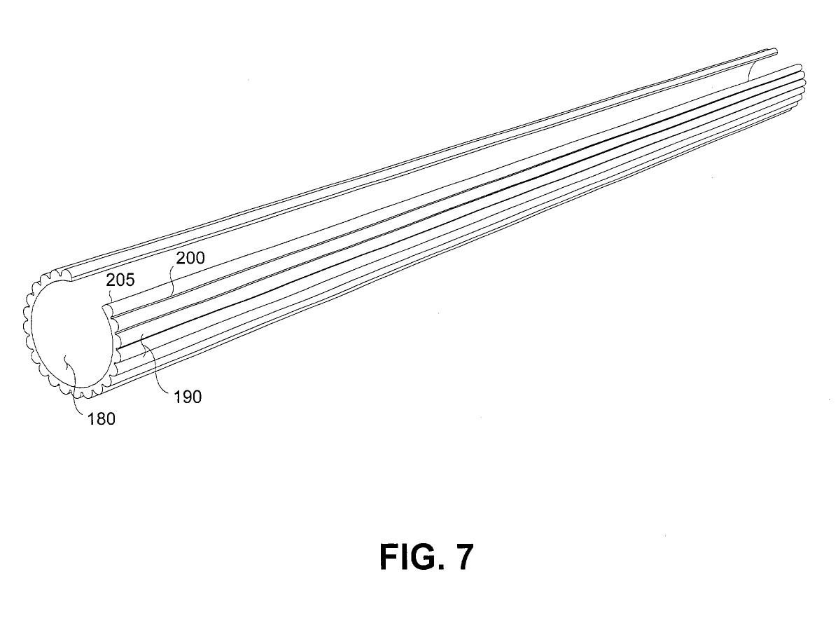

FIG. 7 is a pictorial diagram of one example embodiment of a decorative shroud according to the present invention. According to this example embodiment, a decorative shroud comprises a pliable material performed into a strip having an inner surface and an outer surface 190. The pliable material may optionally be “pre-performed” into a circular profile and dispensed linearly relative to the profile. However, the pliable material is generally maintained a substantially flat positioned. According to this example embodiment, the outer surface comprises a ribbon cable facade such that grooves 200 are introduced into the surface linearly with a relationship to the strip constituting the pliable material. The grooves may be formed by a partial circle pattern 205 so as to provide the visual appearance of linearly adjacent cables running the length of the strip. According to one embodiment of the present invention, the pliable material may be thermally formed in order to emboss the grooves into said outer surface. Any pliable material, e.g. PTFE or poly-vinyl-chloride, may be used in constructing the decorative shroud.

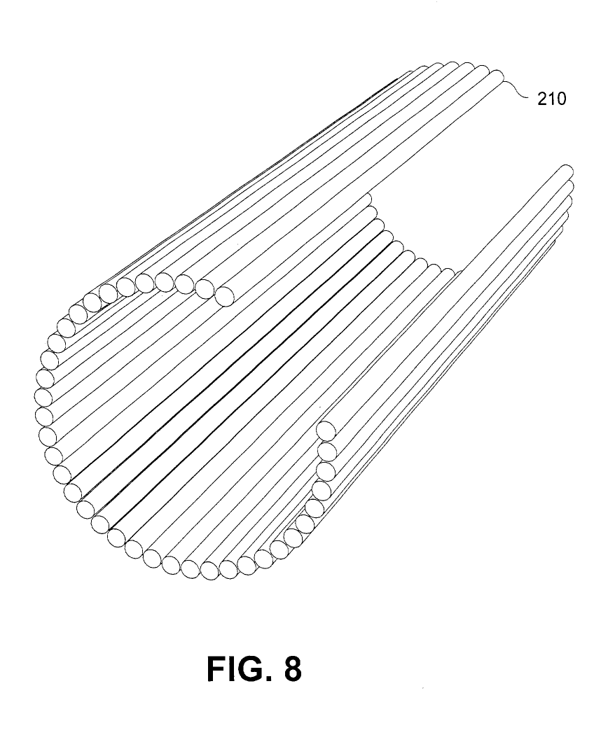

FIG. 8 is a pictorial diagram that depicts one alternative embodiment of a decorative shroud according to the present invention. According to this alternative embodiment, a decorative shroud comprises a ribbon cable comprising a plurality of linearly adjacent cylindrical members 210. These cylindrical members 210 may comprise electrical cable (e.g. network or communications cable). The ribbon cable may be constructed according to the teachings of the present invention heretofore described.

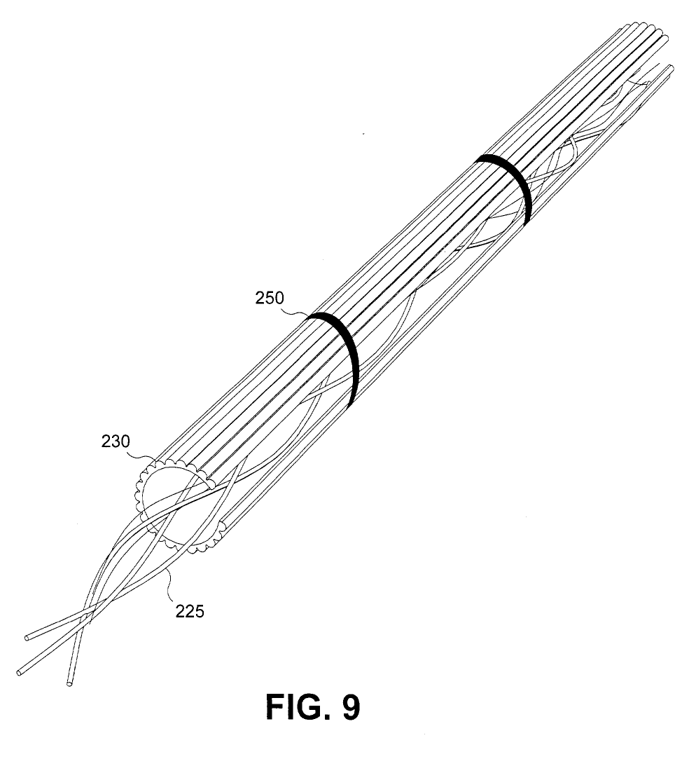

FIG. 9 is a pictorial diagram that depicts the usage of the decorative shroud to encase a bundle of network or communications cables according to the teachings of the present invention. Where a bundle of cables 225 may exist in disarray, e.g. they are not positioned in a linearly adjacent manner; a decorative shroud 230 may be disposed about the bundle of cables 225. The bundle of cables 225 may be temporarily or permanently contained so that they may be positioned within the envelope of the decorative shroud 230. This may be accomplished by either physically holding the cables together (e.g. to effect a temporary containment) or by tying the cables together at intervals (e.g. by using wire ties). Once the decorative shroud 230 is in position about the bundle of cables 225, it may be secured in place. According to one alternative method, this may be accomplished through the use of wire ties 250.

### ALTERNATIVE EMBODIMENTS

While this invention has been described in terms of several preferred embodiments, it is contemplated that alternatives, modifications, permutations, and equivalents thereof will become apparent to those skilled in the art upon a reading of the specification and study of the drawings. It is therefore intended that the true spirit and scope of the present invention include all such alternatives, modifications, permutations, and equivalents.

What is claimed is:

1. A method for interconnecting communication or network subsystems comprising:
determining the distance between two subsystems;
determining the number of ports requiring interconnection;
securing a length of ribbon cable comprising a plurality of cables selected from the group of communications cable and network cables;
adjusting the length of individual cables constituting the ribbon cable;
introducing a length adjusted end of the ribbon cable into a subsystem;
terminating the length adjusted ends of the individual cables with a connector; and
mating the connector to a receptacle constituting a first network subsystem.

2. The method of claim 1 further comprising the steps of:
positioning the ribbon cable in a cable-way;
fanning a cable away from the ribbon cable; and
directing the fanned away cable to an access port.

3. The method of claim 1 further comprising the step of:
adjusting the number of individual cables constituting the ribbon cable.

4. The method of claim 1 further comprising the step of:
rolling the ribbon cable into a bundle.

5. A method for dressing a plurality of linearly adjacent communications or network cables comprising:
containing the plurality of cables in a bundle; and
encasing the bundle in a decorative shroud.

6. The method of claim 5 wherein the step of containing the plurality of cables comprises wrapping the plurality of cables with a restraint at intervals.

7. The method of claim 5 wherein the step of encasing the bundle in a decorative shroud comprises the steps of:
enveloping the bundle with a linear ribbon cable comprising a plurality of cables; and
restraining the linear ribbon cable about the bundle.

8. The method of claim 5 wherein the step of shrouding the bundle comprises the steps of:
enveloping the bundle with a linear casing comprising a ribbon cable facade; and
restraining the linear casing about the bundle.

9. A ribbon cable comprising:
plurality of cables selected from the group consisting of a communications cable and a network cable wherein said cables are fixed in a side-by-side relationship.

10. The ribbon cable of claim 9 wherein the cables are fixed in place by a common insulator encapsulating the plurality of cables.

11. The ribbon cable of claim 9 wherein the cables are fixed in place by an adhesive at a minimum deposited between said cables.

12. The ribbon cable of claim 9 wherein the cables are fixed in place by a flexible planar attached to the perimeter of each cable.

13. A linear cable casing comprising a linear strip having an internal surface and an external surface and wherein said external surface comprises a ribbon cable facade.
